(19) United States
(12) Patent Application Publication
(10) Pub. No.: US 2013/0124484 A1
(43) Pub. Date: May 16, 2013

(54) Persistent flow apparatus to transform metrics packages received from wireless devices into a data store suitable for mobile communication network analysis by visualization

(71) Applicant: GEORGE E. HOFFMAN, SAN JOSE, CA (US)

(72) Inventor: GEORGE E. HOFFMAN, SAN JOSE, CA (US)

(73) Assignee: CARRIER IQ, INC., MOUNTAIN VIEW, CA (US)

(21) Appl. No.: 13/680,045

(22) Filed: Jan. 9, 2013

Related U.S. Application Data
(62) Division of application No. 12/753,736, filed on Apr. 2, 2010.

(51) Int. Cl. G06F 17/30

(52) U.S. Cl. CPC G06F 17/30289
USPC 707/688

(57) ABSTRACT

A persistent flow apparatus maintains a datamart store with up-to-date transformations of packages as the packages are received from wireless recording devices. Each flow apparatus generates measures in a format which can be interactively analyzed along certain dimensions. A persistent flow is stateful to incrementally process metrics packages over multiple collection periods which are not correlated with the times the metrics are recorded at the device. A persistent flow is data driven by the receipt of new packages received from wireless recording devices having selected attributes and ignores unqualified packages.

This application is a division of application Ser. No. 12/753,736 filed Apr. 2, 2010 which is incorporated by reference in its entirety. A related U.S. Pat. No. 7,609,650 discloses COLLECTION OF DATA AT TARGET WIRELESS DEVICES USING DATA COLLECTION PROFILES which determines the contents of metrics packages as used in the present patent application, the metrics packages known to those skilled in the art.

### BACKGROUND

It is known that relational databases provide flexibility in analysis but become ineffective for interactive analysis with too much detailed data from too many sources. What is needed is a method for transforming a extremely broad data set into aggregations and categories which may be examined along meaningful dimensions. What is further needed is a set of predefined dimensions of a datamart, reports, and graphs which can be automatically populated and rapidly manipulated interactively, upon a schedule, or triggered upon receipt of new data. What is needed is improved efficiency in managing large volumes of substantially unstructured data.

### SUMMARY OF EMBODIMENTS OF THE INVENTION

One aspect of the invention is a persistent flow apparatus which maintains a non-transitory computer-readable datamart store with up-to-date transformations of packages as the packages are received from wireless recording devices. The dimensions of each hypercube by which key performance indicators may be displayed and the visualization modalities are defined by the flow method which controls the operation of a processor. The criteria on which metrics packages are accepted or rejected are set. Rules are selected for transforming the metrics into measures. Certain attributes of the measures are stored along with references to decode metrics and aggregations of measures into logical groups. Enrichments are applied to related measures to determine facts which have operational intelligence. A persistent flow is enabled to process metrics packages incrementally over several periods of collection and reporting without reinitializing the transformation process. The flow method provides a contract for delivering certain measures in a format which can be interactively analyzed along certain dimensions. Generally expected optimizations and statistics are pre-calculated for convenient analysis and rapid display. In an embodiment of the invention, a flow defines the dimensions of at least one hypercube, which is populated only upon demand. In an embodiment of the invention, a flow defines the dimensions of at least one hypercube, including transformation of metrics which are computed and stored into a data mart. In an embodiment of the invention, a flow defines the dimensions of at least one hypercube, which provides optimization hints to indexing and storage of data conducive to facilitate anticipated access and analysis. In an embodiment a flow provides means for verification of metric packages. In an embodiment a flow provides means for error reporting directives. In an embodiment, a flow provides means for dependency tracking of which metrics must be combined to yield desired attributes. In an embodiment, a flow provides for persistent operation, which distinguishes newly collected packages from previously processed packages and builds on intermediate results to keep a datamart fresh without reprocessing the accumulated collection packages.

### BRIEF DESCRIPTION OF DRAWINGS

FIG. 1 is block diagram of a conventional server comprising a exemplary processor configured to perform instructions encoded on machine readable media.

FIGS. 2A and 2B is a flow chart of steps in a flow.

FIGS. 3A and 3B is a block diagram of a system which comprises a Flow.

### DETAILED DISCLOSURE OF EMBODIMENTS

### Definitions:

Metric—An attributed object that gets received from the device, with an associated serialization format. Our embodiment is a an arbitrarily complex machine-readable structure, defined and parsed via a formal meta-data-rich format, but it could as easily be a textual log message in some well-defined format. The definition of a metric implies a serialized format.

Attribute: A named, typed value. Metrics, measures, and facts all have named attributes with declared types.

Package: A collection of metrics. Usually the whole collection is associated with one or more discrete events, like a voice call, but this is not necessarily the case.

Measure factory: A SIM component that takes single packages at-a-time as input and some number of measures as output. A measure factory is configured with the type of measures you'd like it to output, and which attributes of that type of measure you want output.

Measure: An attributed object that gets produced by a measure factory. Although the attributes can be typed, there is no particular serialization format implied by the definition of a measure. There is often, but not always, a one-to-one relationship between packages and measures, in that a single measure might summarize all of the data in a single package.

Enrichment: A SIM component that takes multiple measures at-a-time as input and produces some number of measures as output. Often, an enrichment will effectively perform an intelligent “join” between different types of measures.

Fact: A measure that gets made available in the final datamart. In database terms (and in a database-based datamart) it would get placed into a ‘fact table’, with each attribute of the measure potentially becoming a column in the database. In practice, the number of facts directly accessible in the datamart may be less than the number of measures processed; for example, measures might be filtered for relevance before becoming facts.

Dimension: A designation applied to a categorical attribute of one or more types of facts. This designation, when applied to attributes of several types of facts, implies that those attributes all express values in the same categorical domain. This designation is used to select or identify certain facts in a set of facts; “all facts where dimension X==foo” might then map to “all facts of type Y with attribute A==foo, and all facts of type Z with attributes B==foo”.

Aggregation (“KPI”): A calculation defined across some population of facts, in terms of attributes of those facts. Aggregation X might be defined as the sum (or average, or standard deviation, or <insert custom logic here>) of all attributes Y of a population of facts of type Z.

Rollup: A declaration of a datamart requirement that a particular set of aggregations must be available with respect to segmentation induced by crossing a particular set of dimensions. A rollup would say “I want aggregations X, Y, and Z to be available with respect to dimensions A, B, and C.” The number of cells of the (potentially virtual, or calculated on-demand) hypercube of resulting data is defined as:

<all possible values of A>*<all possible values of B>*<all possible values of C>

. . . and each cell would have a corresponding value for aggregations X, Y, and Z.

Datamart: The present patent application defines a datamart as a data store which can respond to a set of queries that follow a set of rules and are restricted to a domain. A datamart contains facts classified along specified dimensions. An example of a datamart is a store containing key performance indicators which are retrievable by a set of dimensions. A non-limiting exemplary embodiment of a datamart is a grid comprising a set of servers adapted to operate as a single parallel machine which has data available to respond to queries. A non-limiting exemplary embodiment of a datamart is a relational database containing metadata allowing access by intelligent clients. A datamart further comprises an organizational scheme even if not yet populated, for aggregated data which can be manipulated to satisfy queries.

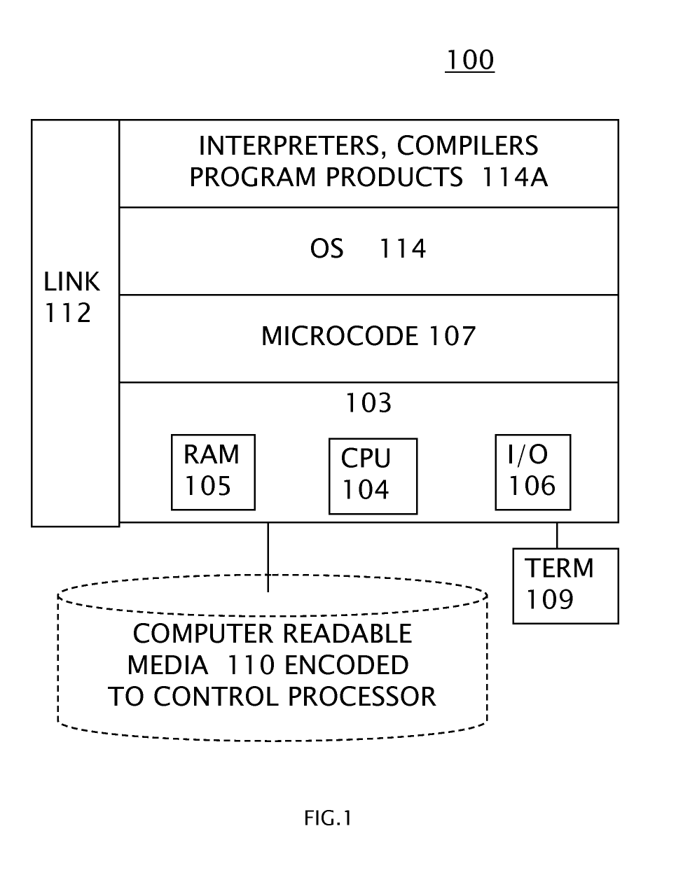

Referring now to the drawings, FIG. 1 illustrates a non-limiting exemplary conventional server known in the art comprising hardware and software configured to execute instructions and communicate to attached networks and input output devices.

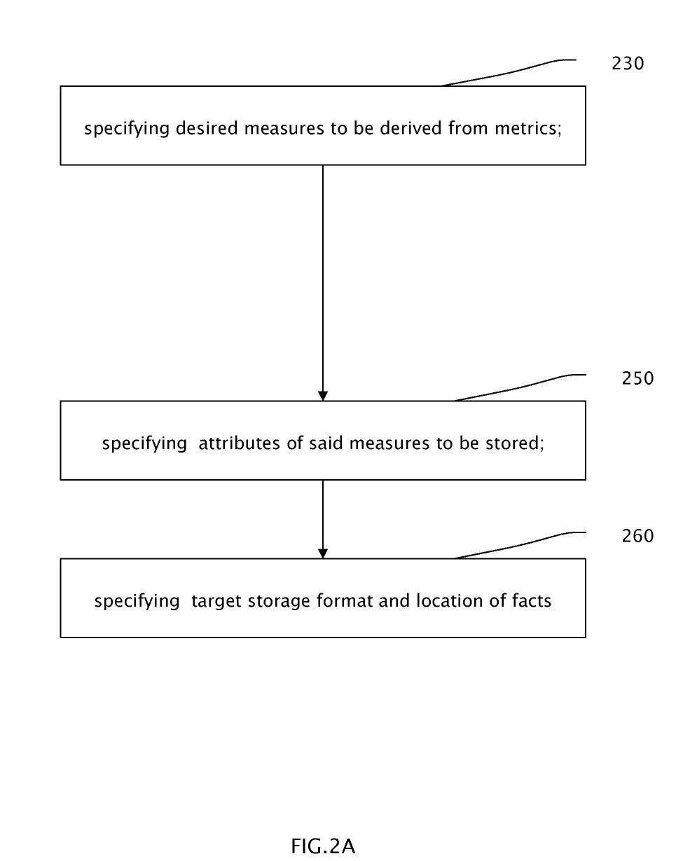

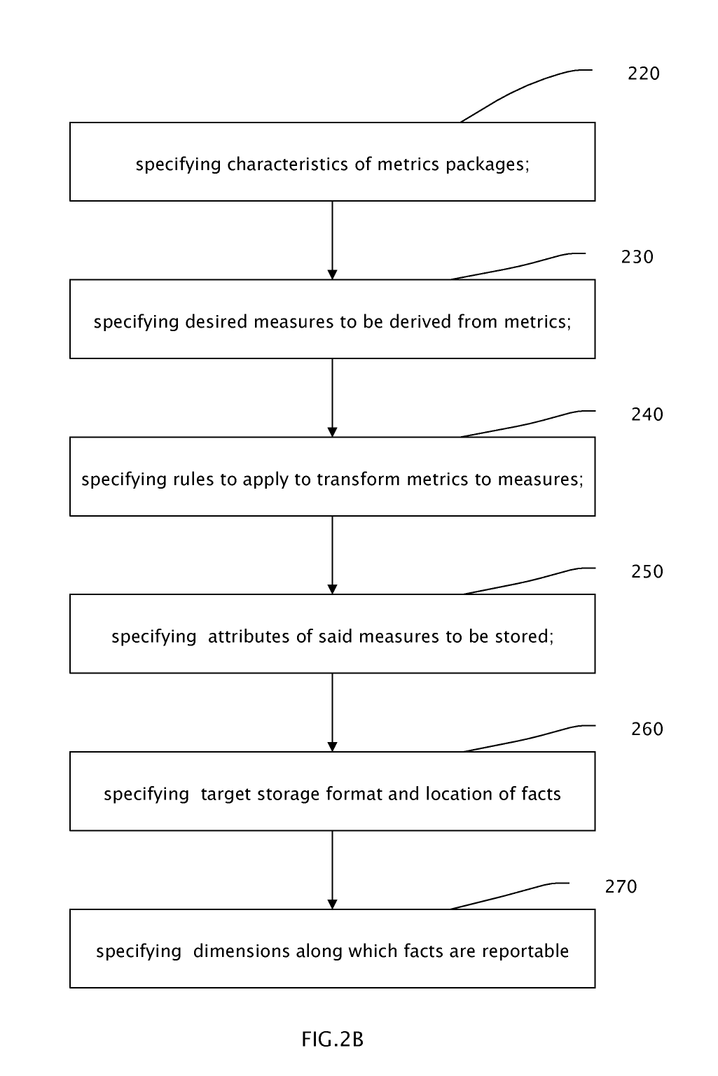

Referring now to FIG. 2A, a flowchart of the present invention method comprises steps embodied as computer instructions as follows:
specifying desired measures to be derived from metrics 230;
specifying attributes of said measures to be stored 250; and
specifying target storage format and location of facts 260.

Referring now to FIG. 2B, the method shown in FIG. 2A is shown with additional steps of:
specifying characteristics of metrics packages 220;
specifying rules to apply to transform metrics to measures 240; and
specifying dimensions along which facts are reportable 270.
   Characteristics of metrics packages include reasons for qualifying or for disqualifying a particular package from the analysis. A package may be too old or too new. A package may be from devices, versions, or locations that are not interesting. A package may be redundant to data already processed. Certain collection profiles are specified for particular flows. Once a significant sample size has been collected, additional processing would not add to the information value of the stored data except in reducing estimate of error.

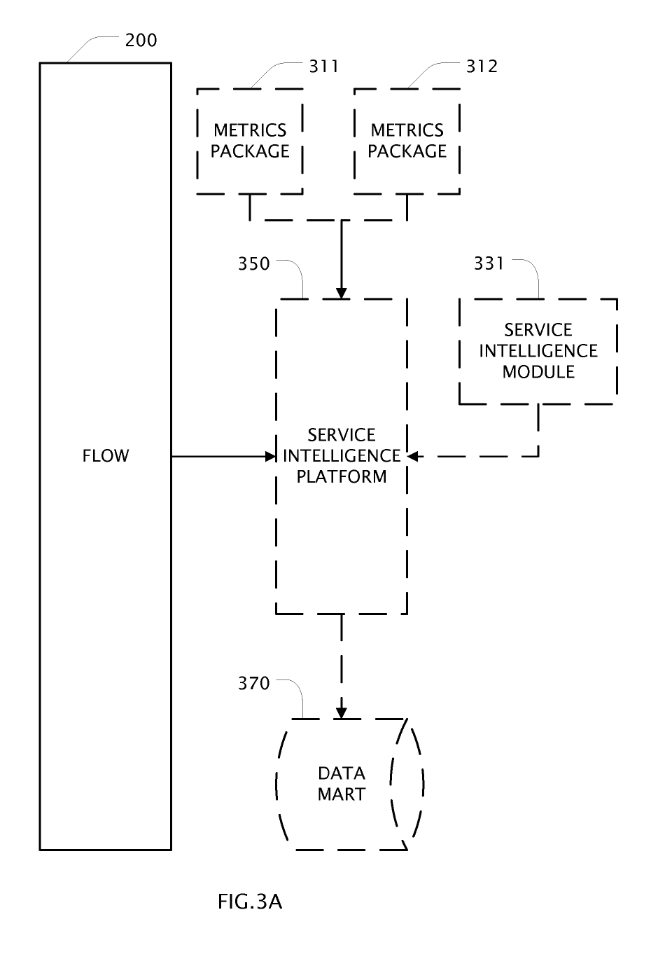

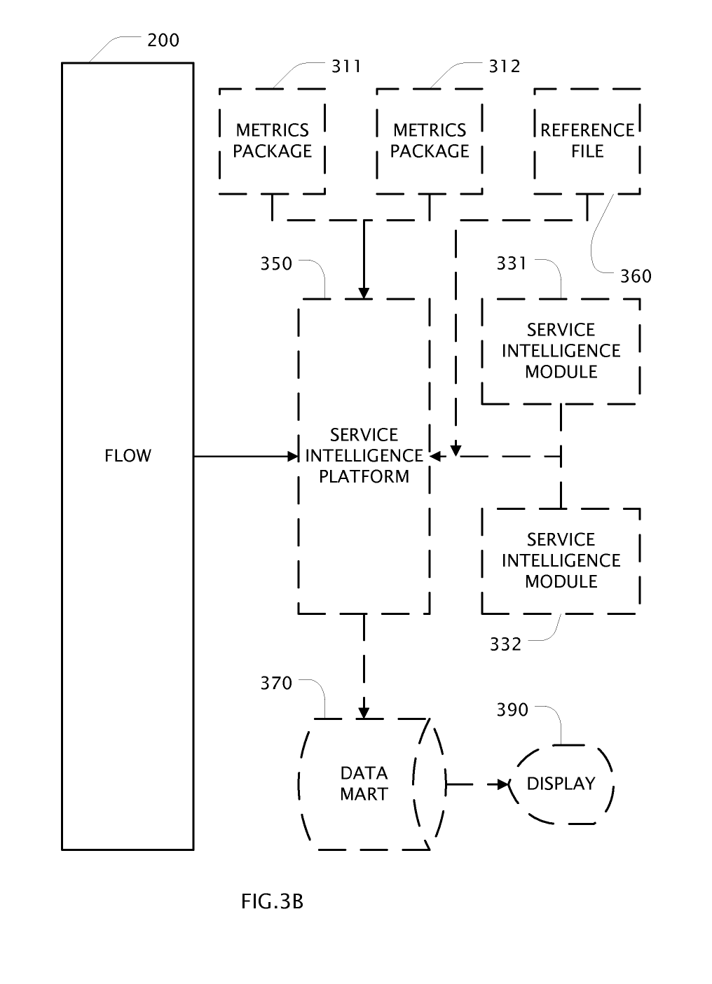

Referring now to FIG. 3A, a data flow diagram is illustrated which shows the relationship of the flow to the rest of the system. A flow 200 specifies to a service intelligence platform 350 what metrics packages 311 312 it examines as inputs, the transformations it applies to the metrics which may be found in at least one service intelligence module 331, and the format and location of the facts to be stored, a datamart 370.

Referring now to FIG. 3B, a flow 200 may also specify other resources. In an embodiment, a flow may specify a reference file 360. In an embodiment, a flow may utilize transformations available from several service intelligence modules 331 332. In an embodiment, the flow may specify the dimensions, style, and format of reports and graphs to be presented on a display 390. Those related data may be tagged in the data mart so that certain methods of analysis available in a service intelligence module 332 are invoked on demand.

A persistent flow comprises a flow definition comprising
which measures are of interest,
which attributes are pertinent to the end study, and
which facts to store and the dimensions by which a user application may access/display/analyze the facts.

The persistent flow further comprises
enrichments of data peculiar to a customer need or usage
filtering of data to eliminate noise or confusion
fixup logic and rules to identify and modify known errors.

In an embodiment, an enrichment is herein defined as a operation across a group of facts or across measures of a certain type. An enrichment operation joins together independent values according to an arbitrary rule. An enrichment is a join of measures from diverse sources according to a specified description. A non-limiting exemplary embodiment of an enrichment is to relate two events by their relative position in time even if they occur on different machines located in different places. A more simple case of enrichment is filtering according to values. Enrichments are ways to recognize a pattern.

An embodiment further comprises
identification of relevant reference files;
display control of what the application can access and show interactively;
specification of aggregations by invoking definitions stored elsewhere; and
specific methods for organizing data into bins or ranges.

A persistent flow further comprises
a target definition/input specification
an output specification comprising the following non-limiting exemplary outputs:
   1. a data feed,
   2. a file format,
   3. a data mart such as but not limited to
      a relational database, and
      a distributed datastore.
reference data which can be used in populating datamart e.g. geographical coordinates vs cell tower, vendors of base stations, service history.

A flow definition comprises
a declaration of facts to be output
a declaration of measures to be derived directly or indirectly by processing metrics packages and
a declaration of attributes of each measure which will be of interest.

Embodiments of the invention further comprise:
specification of fixups to data, e.g. translate archane text strings to code names, analogous to spellchecking, removing redundancies or noise,
filtering of data e.g. discarding known bad versions/corrupt data sets,
enrichments of data e.g. cross correlations from independent data streams.

Aspects distinguishing the invention further comprise:
Dimensions according to which data may be easily displayed;
Aggregations of data to be stored into the datamart; and
Rollups, defined as combinations of dimensions and aggregations, which define those dimensions by which data may be accessed and which serve as hints for storing, pre-calculating, or indexing the data store.

In an embodiment each rollup defines the dimensions of a hypercube. The hypercube may be populated prior to analysis or simply defined for later computation or loading. The rollup specifies what may in future be asked about and provides a hint for organizing the store or index table. Rather than placing all data into a single hypercube, a sparse matrix may be constructed to leave out data which is not of interest. Or portions of the data which reflect normal, non-problematical behavior rarely accessed may be placed in larger bins with less granularity or fewer indices.

Embodiments of the invention further comprise application of tags to control display of data:
which dashboard may display each data, each kpi;
colors to display a certain type of data;
charts in which to display a certain type of data;
which kpi's are available to certain dashboards;
which data is easily displayable against which other data e.g. which knob or slider to move display;
types of presentation available for each data e.g. which graphs may be displayed;
manipulations easily available for each data; and
which data are categorized as independent variables and which are dependent variables for analysis of variations to determine sensitivity, correlation, or randomness.

In an embodiment, a Flow comprises a computer-implemented method for operating a server adapted by instructions encoded on computer-readable media for analyzing device-recorded performance data comprising instructions controlling a processor:
controlling a service intelligence platform;
retrieving a plurality of metrics packages collected and stored in a grid computing network;
selecting at least one service intelligence module to operate on the metrics packages;
selecting a plurality of metrics packages on the basis of meta-data about the environment and event history of the recording devices;
specifying attributes of measures which each service intelligence module is capable of deriving from the metrics packages;
controlling the service intelligence platform to enrich measures by applying domain knowledge to measures obtained from a plurality of packages;
controlling the service intelligence platform to aggregate measures after enrichment to derive service facts and store said facts into a multi-dimensional data store adapted for interactive analysis; and
controlling the service intelligence platform to store with each fact, identity information about the chain of packages and service intelligence modules from which each fact was derived.

One embodiment of the invention comprises a method comprising executable instructions to configure a processor:
specifying desired measures to be derived from metrics;
specifying attributes of said measures to be stored; and
specifying a storage format and location of facts determined.

In an embodiment, the method further comprises specifying disqualifying characteristics of metrics packages not to be processed.

In an embodiment, the method further comprises checking for required characteristics of metrics packages to be processed. In an embodiment, required characteristics comprise a profile identification.

In an embodiment, the method further comprises specifying a plurality of rules to process data. In an embodiment, the method further comprises a process for adding new data to accumulate results over a plurality of periods.

In an embodiment, attributes are selected from the list: where, when, why, how long or how short, how, numerical grades for quality, speed, and difficulty.

In an embodiment, a target storage location is a server providing a relational database. In an embodiment, a storage format is comma delimited text.

In an embodiment, the method further comprises

specifying enrichment methods from a plurality of service intelligence modules to be combined to produce a fact. In an embodiment, an enrichment method combines data sourced from different packages, different origins, and recorded at different times to determine a fact not visible at a single mobile device or a single cellular tower.

In an embodiment, the method further comprises

state tracking to enable incremental processing of collected data. In an embodiment, state tracking comprises processing data collected between a start date and an end date and combining with data processed at a different period.

In an embodiment, the method further comprises

filtering and fixing data with reference files to add human understanding of data. In an embodiment, fixing data comprises translating data and text strings into descriptive text according to a reference file. In an embodiment, filtering data comprises eliminating data which is erroneous or not pertinent to the objective of a study.

In an embodiment, a reference file comprises computer-readable imported data used in conjunction with metrics collected at a mobile agent. In an embodiment, a reference file comprises computer-readable geographic location information.

In an embodiment, a reference file comprises computer-readable equipment configuration lists. In an embodiment, a reference file comprises a computer-readable table mapping of device id to user demographic or to marketing information.

In an embodiment, the method further comprises

precomputing and storing hypercubes of data for ease of presentation upon demand.

In an embodiment, the method further comprises

declaring by which dimensions are declared for each hypercube across which recorded data may be displayed.

In an embodiment, the method further comprises

specifying graphical display formats for each fact and visibility controls.

In an embodiment, a format specifies the color, fonts, and icons associated with certain values for display. In an embodiment, a visibility control enables graphing or display of one variable as a function of an other variable in the data mart.

In an embodiment, the method further comprises

specifying dimensions stored for each data hypercube.

In an embodiment, hypercubes of data are precomputed facts stored for ease of presentation upon demand.

In an embodiment, dimensions are declared for each hypercube across which recorded data may be analyzed.

In an embodiment, the method further comprises

specifying formulas and formats for reports and statistics which can be computed for each fact in the data mart. In an embodiment, a format comprises a table, chart, or graph of values in a multi-dimensional matrix of measurements and the correlation among the measurements. In an embodiment, a formula comprises an equation for determining a key performance indicator derived from metrics collected by Carrier IQ agent embedded within a mobile communication device.

In an embodiment, the method further comprises

specifying aggregations of data to abstract information into categories or ranges.

In an embodiment, the method further comprises

specifying aggregations traceable to their original data packages and the service intelligence modules used to process them.

In another embodiment, the invention comprises a system comprising means for

controlling a service intelligence platform;

retrieving a plurality of metrics packages collected and stored in a grid computing network;

selecting at least one service intelligence module to operate on the metrics packages;

selecting a plurality of metrics packages on the basis of meta-data about the environment and event history of the recording devices;

specifying attributes of measures which each service intelligence module is capable of deriving from the metrics packages;

controlling the service intelligence platform to enrich measures by applying domain knowledge to measures obtained from a plurality of packages;

controlling the service intelligence platform to aggregate measures after enrichment to derive service facts and store said facts into a multi-dimensional data store adapted for interactive analysis; and

controlling the service intelligence platform to store with each fact, identity information about the chain of packages and service intelligence modules from which each fact was derived.

In an embodiment, required characteristics comprise a profile identification wherein a profile is a data collection profile disclosed in related U.S. Pat. No. 7,609,650, COLLECTION OF DATA AT TARGET WIRELESS DEVICES USING DATA COLLECTION PROFILES.

In an embodiment, certain service intelligence modules comprises domain specific bodies of knowledge, best practices, or common assumptions.

In an embodiment, a flow further comprises instructions for controlling a processor to check contents of packages and report errors if the packages do not contain the correct data. In an embodiment, a flow further comprises instructions for controlling a processor to generate a collection profile to fulfill a contract by collecting the metrics upon which a measure depends. In an embodiment, a flow further comprises instructions for controlling a processor to route error messages if a package is inadequate, if a measure cannot be produced from the available packages, if profile cannot be generated to fulfill a contract according to dependency tracking from the desired hypercubes.

As is well known in the art, the techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors, such as the illustration of FIG. 1, executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

A number of embodiments of the invention have been described. Nevertheless, it will be understood that various modifications may be made without departing from the spirit and scope of the invention. For example, Wireless and Wired Communication Devices, Electronic Books, Games, and Computing Environments are non-limiting exemplary embodiments. As indicated herein, embodiments of the present invention may be implemented in connection with a special purpose or general purpose telecommunications device, including wireless and wireline telephones, other wireless communication devices, or special purpose or general purpose computers that are adapted to have comparable telecommunications capabilities. Embodiments within the scope of the present invention also include computer-readable media for carrying or having computer-executable instructions or electronic content structures stored thereon, and these terms are defined to extend to any such media or instructions that are used with telecommunications devices.

By way of example such computer-readable media can comprise RAM, ROM, flash memory, EEPROM, CD-ROM or other optical disk storage, magnetic disk storage or other magnetic storage devices, or any other medium which can be used to carry or store desired program code in the form of computer-executable instructions or electronic content structures and which can be accessed by a general purpose or special purpose computer, or other computing device.

Computer-executable instructions comprise, for example, instructions and content which cause a general purpose computer, special purpose computer, special purpose processing device or computing device to perform a certain function or group of functions.

Although not required, aspects of the invention have been described herein in the general context of computer-executable instructions, such as program modules, being executed by computers in network environments. Generally, program modules include routines, programs, objects, components, and content structures that perform particular tasks or implement particular abstract content types. Computer-executable instructions, associated content structures, and program modules represent examples of program code for executing aspects of the methods disclosed herein.

The described embodiments are to be considered in all respects only as exemplary and not restrictive. The scope of the invention is, therefore, indicated by the appended claims rather than by the foregoing description. All changes which come within the meaning and range of equivalency of the claims are to be embraced within their scope.

### CONCLUSION

In the present patent application, inventor defines a Flow as a computer-implemented method for operating a server adapted by instructions encoded on computer-readable media for analyzing device-recorded performance data comprising instructions controlling a processor which can be easily distinguished from conventional methods by its:
controlling a service intelligence platform;
retrieving a plurality of metrics packages collected and stored in a grid computing network;
selecting at least one service intelligence module to operate on the metrics packages;
selecting a plurality of metrics packages on the basis of meta-data about the environment and event history of the recording devices;
specifying attributes of measures which each service intelligence module is capable of deriving from the metrics packages;
controlling the service intelligence platform to enrich measures by applying domain knowledge to measures obtained from a plurality of packages;
controlling the service intelligence platform to aggregate measures after enrichment to derive service facts and store said facts into a multi-dimensional data store adapted for interactive analysis; and
controlling the service intelligence platform to store with each fact, identity information about the chain of packages and service intelligence modules from which each fact was derived.

A flow is distinguished from a conventional method known in the art by operating in a persistent manner to improve performance and to keep data fresh while still collecting packages. A flow provided intermediate results in a datamart while continuing on a scheduled basis to add newly collected data packages as samples to a study. A flow provides tags which relate aggregations to domains. These tags call out characteristics or attributes which may be utilized in presentation of the data. A flow sets the dimension of an interactive space which may be fulfilled on the demand of a user or on a scheduled process.

What is claimed is:

1. An apparatus comprising a processor and memory configured to
control a service intelligence platform;
retrieved a plurality of metrics packages collected from wireless recording devices and stored in a grid computing network;
select at least one service intelligence module to operate on the metrics packages;
select a plurality of metrics packages on the basis of meta-data about the environment and event history of the wireless recording devices;
specify attributes of measures which each service intelligence module shall derive from the metrics packages;
control the service intelligence platform to enrich measures by applying domain knowledge to measures obtained from a plurality of packages received from wireless recording devices;
control the service intelligence platform to aggregate measures after enrichment to derive service facts and store said facts into a multi-dimensional data store adapted for interactive analysis; and
control the service intelligence platform to store with each fact, identity information about the chain of packages and service intelligence modules from which each fact was derived.

2. A system to collect and transform data packages from wireless recording devices into an up-to-date datamart for analysis of network characteristics comprising a processor and memory configured to provide:
storage for a plurality of hypercubes of data containing precomputed facts stored for ease of presentation upon demand along dimensions,
a plurality of key performance indicator determination circuits which transform a plurality of metrics collected by an agent on a wireless recording device,
an aggregation circuit to group data packages into ranges or similar categories,
a state tracker to enable incremental processing of newly collected data, and
a computer-readable non-transitory store to enable processing data collected between a first start date and a first end date and combining with data collected between a second start date and second end date.
